(19) United States
(12) Patent Application Publication
(10) Pub. No.: US 2006/0222779 A1
(43) Pub. Date: Oct. 5, 2006

(54) Glow discharge-generated chemical vapor deposition

(76) Inventors: Aaron M. Gabelnick, Naperville, IL (US); Christina A. Lambert, Midland, MI (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/567,144

(22) PCT Filed: Sep. 7, 2004
(86) PCT No.: PCT/US04/29442

§ 371 Date: Feb. 6, 2006

(30) Foreign Application Priority Data
Sep. 9, 2003 (US) 60501477

(51) Int. Cl. H05H 1/24

(52) U.S. Cl. 427/569

(57) ABSTRACT

A process for creating plasma polymerized deposition on a substrate using a glow discharge is described. The glow discharge is created between an electrode and a counterelectrode. A mixture of a balance gas and a tetraalkylorthosilicate is flowed through the glow discharge onto a substrate to deposit a coating onto the substrate as an optically clear coating or to create surface modification. The process, which is preferably carried out at or near atmospheric pressure, can be designed to create an optically clear powder-free or virtually powder free coating.

### PRIORITY

This application claims priority from U.S. Provisional Application No. 60/501,477 filed 9 Sep. 2003.

### FIELD

The present invention relates to coating or modifying a substrate using glow discharge-generated chemical vapor deposition.

### BACKGROUND

The use of widely available and inexpensive polymers such as polyolefins is often limited by the undesirably low surface energy of these polymers. Consequently, more expensive materials having higher surface energy are often used where surface wettability or adhesion or both, are required. In recent years, an alternative approach has been developed, namely surface modification of low surface energy polymers using corona or plasma discharge (termed “glow discharge” herein).

For example, U.S. Pat. No. 5,576,076 (Slootman et al.) teaches that the performance of polyolefin film can be improved by creating a deposit of silicon oxide on a traveling substrate by subjecting the substrate to a glow discharge at atmospheric pressure in the presence of a silane such as SiH₄, a carrier gas, and oxygen or a gas capable of producing oxygen. Although the method described by Slootman et al. does indeed render the surface of the polymer more wettable, it suffers from at least two drawbacks. First, the preferred working gas (SiH₄) is an extremely hazardous material that ignites spontaneously in air; second, the deposition of silicon oxide tends to be in the form of a powder, the creation of which limits the scope of potential applications and which can foul equipment.

Glow discharge plasma enhanced chemical vapor deposition (PECVD) has been used to produce coatings on substrates to improve their resistance to chemicals, wear, abrasion, scratching, and gas permeation. For example, in U.S. Pat. No. 6,106,659, Spence, et al. describes a cylinder-sleeve electrode assembly apparatus that generates plasma discharges in either an RF resonant excitation mode or a pulsed voltage excitation mode. The apparatus is operated in a rough-vacuum mode, with working gas pressures ranging from about 10 to about 760 Torr. Operation at rough-vacuum pressure is said to have advantages over operation at strictly atmospheric pressure because the required supply gas flow rate is significantly reduced compared to strictly atmospheric operation, allowing for the economical use of more expensive specialty gases. Furthermore, the generated coatings possess superior properties as compared to coatings formed using conventional glow discharge systems operating either at low or high pressures.

The method described by Spence, et al. suffers from the requirement of rough vacuum, which is a commercial disadvantage over strict atmospheric methods. Thus, it would be an advantage in the art of PECVD to be able to create contiguous (that is, non-powder-forming, i.e., film coatings) coatings at atmospheric pressure.

### SUMMARY OF THE INVENTION

The present invention addresses the deficiencies in the art by providing a process for depositing a film coating on the exposed surface of a substrate, characterized by the steps of: (a) creating a glow discharge in a region between an electrode and a counterelectrode; and (b) flowing a mixture comprising a balance gas, a tetraalkylorthosilicate and, optionally, a carrier gas for the tetraalkylorthosilicate through the glow discharge and onto or in the vicinity of at least one surface of said substrate at a flow velocity of from about 0.05 m/s to about 5 m/s, the concentration of the tetraalkylorthosilicate in the mixture being in the range of from more than 2000 ppm to about 10000 ppm to form a film coating on the substrate.

### DRAWINGS

FIG. 1 is an illustration of a preferred apparatus used in the process of the instant invention using a hollow perforated electrode and a drum shaped counterelectrode.

FIG. 2 is an illustration of the side view of the electrode and counterelectrode of the apparatus of FIG. 1.

FIG. 3 is a more detailed illustration of the hollow electrode of FIG. 1.

FIG. 4 is an illustration of a hollow electrode structure having holes as outlet ports.

FIG. 5 is is an illustration of another preferred apparatus used in the process of the instant invention using a hollow perforated electrode and a planar counterelectrode.

FIG. 6 is an illustration of the side view of the electrode and counterelectrode of the apparatus of FIG. 5.

### DESCRIPTION

In the process of the present invention, sufficient power density and frequency are applied to an electrode to create and maintain a glow discharge in a spacing between the electrode and a counterelectrode, which is preferably a moving counterelectrode. The power density is preferably at least 1 W/cm² (per cm² of electrode adjacent to the counterelectrode) more preferably at least 5 W/cm², and most preferably at least 10 W/cm²; and preferably not greater than 200 W/cm², more preferably not greater than 100 W/cm², and most preferably not greater than 50 W/cm². The frequency is preferably at least 2 kHz, more preferably at least 5 kHz, and most preferably at least 10 kHz; and preferably not greater than 100 kHz, more preferably not greater than 60 kHz, and most preferably not greater than 40 kHz.

The spacing between the electrode and counterelectrode is sufficient to achieve and sustain a glow discharge, preferably at least 0.1 mm, more preferably at least 1 mm, and preferably not more than 50 mm, more preferably not more than 20 mm, and most preferably not more than 10 mm. The counterelectrode can be in the form of a rotating drum preferably fitted with a dielectric sleeve, and the substrate to be coated is preferably transported along the drum. Alternatively, the counterelectrode can be in the form of a planar electrode preferably fitted with a dielectric cover, and the substrate to be coated is preferably transported by the planar counterelectrode. For the purposes of this invention, the terms electrode and counterelectrode are conveniently used to refer to a first electrode and a second electrode, either of which can be powered with the other being powered or grounded. The electrode can be perforated with perforations therethrough or thereinto which can be in the shape of, for example and without limitation thereto, slots or holes.

A mixture of gases including a balance gas and a tetraalkylorthosilicate, more preferably tetraethylorthosilicate, and optionally a carrier gas for the tetraalkylorthosilicate (together, the total gas mixture) is flowed into the glow discharge and onto the substrate to be coated.

As used herein, “carrier gas” refers to a gas, preferably a nonreactive gas, that provides a convenient means to merge the balance gas with the tetraalkylorthosilicate. Preferred carrier gases include nitrogen, helium, and argon.

As used herein, the term “balance gas” is a reactive or non-reactive gas that carries the working gas through the electrode perforations and ultimately to the substrate. Examples of suitable balance gases include air, oxygen, CO₂, O₃, NO, nitrogen, helium, and argon, as well as combinations thereof The flow rate of the total gas mixture is sufficiently high to drive the plasma polymerizing tetraalkylorthosilicate to the substrate to form a film like coating, as opposed to a rough surfaced, discontinuous coating or a powder. Preferably the flow rate of the total gas mixture is such that the velocity of the gas passing through the perforations is at least about 0.05 m/s, more preferably at least about 0.1 m/s, and most preferably at least about 0.2 m/s; and preferably not greater than about 10 m/s, more preferably not greater than about 5 m/s, and most preferably not greater than about 2 m/s. The flow velocity of the gas passing through the perforations of a perforated electrode is determined by dividing the flow rate of gas measured in units of cubic meters per second by the total area of the perforations measured in units of square meters. The flow velocity of the gas passing through a gap (or gaps) between the electrode and the counterelectrode is determined by dividing the flow rate of gas measured in units of cubic meters per second by the total area of the gap (or gaps) measured in units of square meters.

As defined herein “electrode” refers a single conductive perforated element or a plurality of conductive elements spaced apart to create one or more gaps therethrough or thereinto. It should be understood that the gas of the instant invention can be flowed in the gap (or gaps) between an electrode and a counterelectrode, or gaps between electrode pairs, and onto a substrate.

In addition to the significance of control of flow rates, control of the relative flow rates of the balance gas and the tetraalkylorthosilicate, which determines the concentration of tetraalkylorthosilicate in the total gas mixture, also contributes to the quality of the coating formed on the substrate. The concentration of the tetraalkylorthosilicate in the total gas mixture entering the glow discharge is sufficient to create a deposit, preferably an optically clear film coating, with a minimization of gas phase nucleation. Gas phase nucleation causes granule and powder formation in the coating, which results in diminished physical properties therein, as well as equipment fouling, which leads to costly downtime. The concentration of the tetraalkylorthosilicate in the total gas mixture is, of course, dependent upon the relative flow rates of the separate streams that form the total gas mixture.

Surprisingly, it has been discovered that unusually high concentrations of tetraalkylorthosilicate can be used at relatively low flow velocity without significant powder formation. The concentration of the tetraalkylorthosilicate is at least about 2000 ppm, preferably at least about 2200 ppm, and more preferably at least about 3500 ppm; and not greater than about 10000 ppm, preferably not greater than about 8000 ppm, and more preferably not greater than 7000 ppm. Although it is possible to carry out the process of the present invention by applying a vacuum or partial vacuum in the glow discharge region, (that is, the region where the glow discharge is formed) the process is preferably carried out so that the glow discharge region is not subject to any significant vacuum or partial vacuum; that is, the process is preferably carried out at atmospheric pressure.

Plasma polymerization in the glow discharge region as carried out by the process of the present invention typically results in an optically clear coated substrate or a surface modified substrate. The term “optically clear” is used herein to describe a film coating having an optical clarity of at least 70 percent, more preferably at least 90 percent, and most preferably at least 98 percent and a haze value of preferably not greater than 10 percent, more preferably not greater than 2 percent, and most preferably not greater than 1 percent. Optical clarity is the ratio of transmitted-unscattered light to the sum of transmitted-unscattered and transmitted-scattered light (<2.5°). Haze is the ratio of transmitted-scattered light (>2.5°) to total transmitted light. (See, for example, ASTM D 1003-97). The film coating can be, for example, a surface modified coating such as an adhesion promoter or an antifog coating; an optical coating such as a reflective or antireflective coating; a transmission enhancement coating; an abrasion resistant coating; or a gas barrier coating for packaging.

The substrate used in the present invention is not limited. Examples of substrates include glass, metal, ceramic, paper, fabric, and plastics, including non-woven plastics, such as polyolefins including polyethylene and polypropylene, polystyrenes, polycarbonates, polyesters including polyethylene terephthalate, polylactic acid and polybutylene terephthalate, and thermoplastic superabsorbent polymers including those described in U.S. Patent Publication 20020039869.

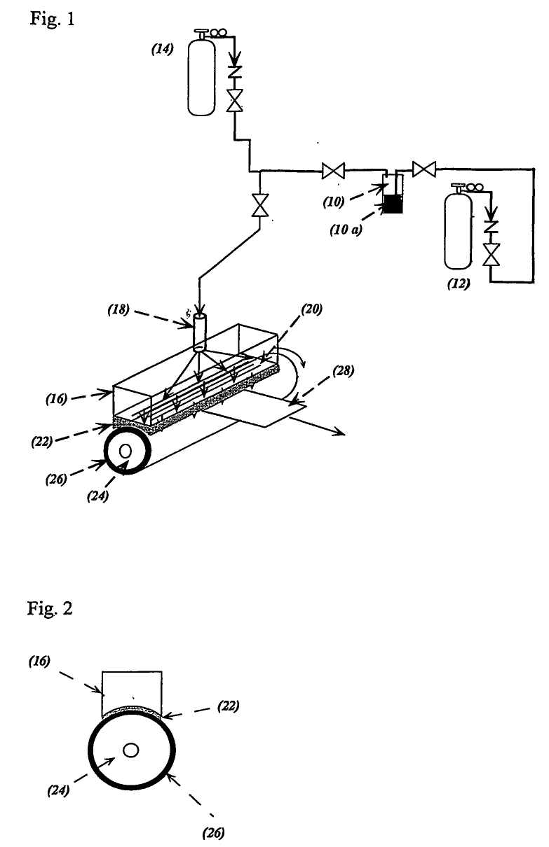

FIG. 1 provides an illustration of a preferred apparatus used in carrying out a preferred method of the present invention. Referring now to FIG. 1, tetraalkylorthosilicate (10) is generated from the headspace of a contained volatile liquid (10a) of the tetraalkylorthosilicate and carried by a carrier gas (12) from the headspace and merged with balance gas (14) to the hollow electrode (16). The carrier gas (12) and the balance gas (14) drive the tetraalkylorthosilicate (10) through the electrode (16), more particularly, through at least one inlet (18) of electrode (16), and through perforations (20), which are typically in the form of slits or holes or the gaps between a plurality of conductive elements. Power is applied to the electrode (16) to create a glow discharge (22) between the electrode (16) and the counterelectrode (24), which is a cylindrical roller preferably fitted with a dielectric sleeve (26). Substrate (28) is passed continuously along the dielectric sleeve (26) and coated with plasma polymerizing tetraalkylorthosilicate, which is preferably a polymerized siloxane.

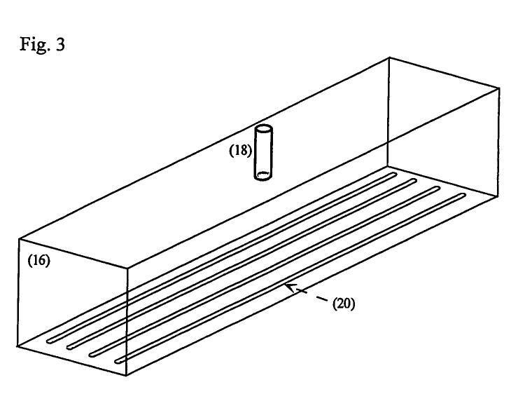

FIG. 2 is a side view illustration of electrode (16), counterelectrode (24), and glow discharge region (22). Where the substrate is conductive, the dielectric layer (26) can be positioned over the electrode (16).

FIG. 3 is an illustration of a preferred embodiment of the electrode perforations (20); which are in the form of parallel or substantially parallel, substantially evenly spaced slits that extend approximately the length of the electrode. The width of the slits is preferably not less than 0.1 mm, more preferably not less than 0.2 mm, and most preferably not less than 0.5 mm; and preferably not more than 10 mm, more preferably not more than 5 mm, and most preferably not more than 2 mm.

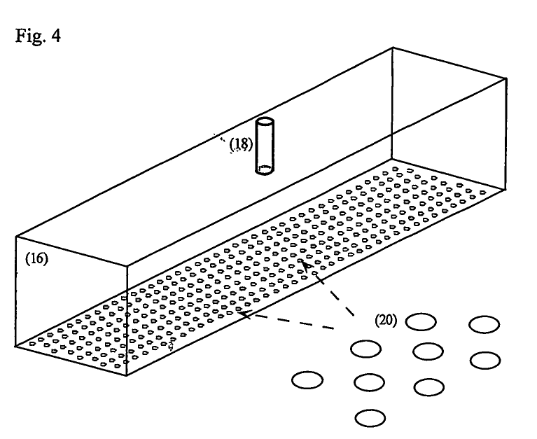

FIG. 4 is an illustration of another preferred geometry and spacing of the electrode perforations (20), which are in the form of substantially circular foramina. If this geometry is used to practice the method of the present invention, the diameter of the outlets is preferably not less than 0.05 mm, more preferably not less than 0.1 mm, and most preferably not less than 0.2 mm; and preferably not greater than 10 mm, more preferably not greater than 5 mm, and most preferably not greater than 1 mm.

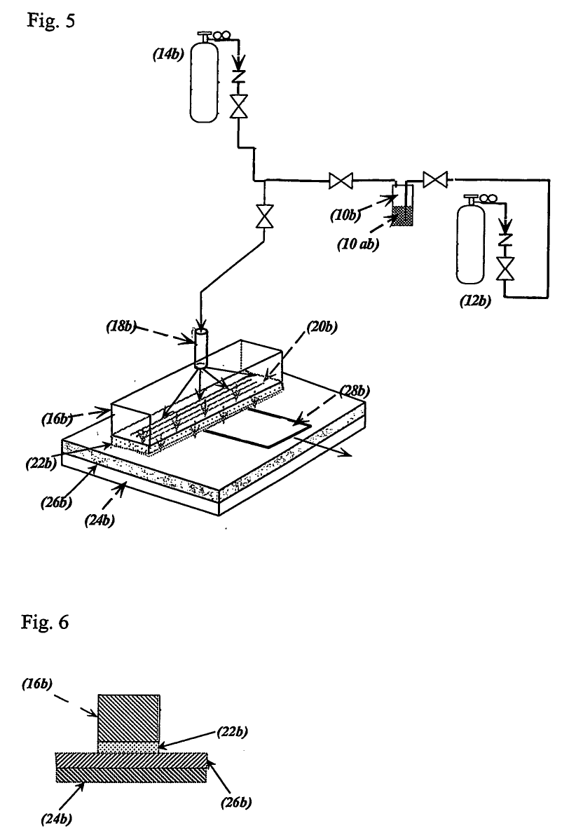

FIG. 5 provides an illustration of another preferred apparatus used in carrying out a preferred method of the present invention. Referring now to FIG. 5, tetraalkylorthosilicate (10b) is generated from the headspace of a contained volatile liquid (10ab) of the tetraalkylorthosilicate and carried by a carrier gas (12b) from the headspace and merged with balance gas (14b) to the hollow electrode (16b). The carrier gas (12b) and the balance gas (14b) drive the tetraalkylorthosilicate (10b) through the electrode (16b), more particularly, through at least one inlet (18b) of electrode (16b), and through perforations (20b), which are typically in the form of slits or holes or the gaps between a plurality of conductive elements. Power is applied to the electrode (16b) to create a glow discharge (22b) between the electrode (16b) and the counterelectrode (24b), which is planar in shape preferably fitted with a dielectric cover (26b). Substrate (28b) is passed continuously along the dielectric cover (26b) and coated with plasma polymerizing tetraalkylorthosilicate, which is preferably a polymerized siloxane.

FIG. 6 is a side view illustration of electrode (16b), counterelectrode (24b), and glow discharge region (22b). Where the substrate is conductive, the dielectric cover (26b) can be positioned over the electrode (16b).

It has been surprisingly discovered that an essentially monolithic, optically clear, contiguous SiOₓ film coating that is essentially powder-free or substantially powder-free can be rapidly deposited continuously on a substrate using the process of the present invention. Indeed, a 10-fold increase of deposition rate has been achieved by significantly increasing the concentration of the tetraalkylorthosilicate and significantly decreasing the flow velocity of the total gas mixture through the perforations of the electrode. Furthermore, the process parameters can be adjusted to form a substrate with surface modification to create, for example, adhesion promotion and antifog properties.

The following examples are for illustrative purposes and are not intended to limit the invention in any way.

### EXAMPLE 1

The coating is prepared using the set-up substantially as illustrated in FIG. 1. The counter electrode and power supply (fixed at 30 Khz) are obtained from Corotec Industries, Farmington, Conn. A 12″ long×6″ wide×6″ high electrode is designed with a single inlet port and 7 outlet perforations in the gaps between the ceramic covered aluminum electrodes.

The substrate is polycarbonate film with a thickness of 7 mil (0.18 mm). Tetraethylorthosilicate (TEOS) is heated to 110° C. and is carried in nitrogen at a concentration of 17 percent v/v and mixed with the balance gas, which is air. The adjusted flow rate of the TEOS is 510 sccm and the flow rate of the balance gas is 5 scfm (142000 sccm) and the concentration of TEOS based on the total gas mixture is calculated to be 3530 ppm. The overall gas velocity to the substrate is calculated to be 0.25 m/s. After 1 second of deposition time the resultant coating had the chemistry of SiOx. The resultant coated film shows much improved wettability compared with uncoated film. The deposition rate of the coating on the substrate is 1.8 micrometers per minute.

### EXAMPLE 2

The process of EXAMPLE 1 is repeated using a TEOS concentration of 2100 ppm. The deposition rate of the coating on the substrate is 1 micrometer per minute.

### EXAMPLE 3

The coating is prepared using the set-up substantially described in Example 1. The substrate is an 18 gsm polypropylene nonwoven sheet. TEOS is heated to 110 C and is carried in nitrogen at a concentration of 17 percent v/v and mixed with the balance gas, which is air. The adjusted flow rate of the TEOS is 850 sccm and the flow rate of the balance gas is 5 scfm (142000 sccm) and the concentration of TEOS based on the total gas mixture is calculated to be 5780 ppm. The polypropylene nonwoven sheet is run through the system at speeds ranging from 3 to 80 m/min. The surface energy is found to be 35 dynes/cm for the uncoated substrate and 72 dynes/cm for the coated substrate.

### EXAMPLE 4

The coating is prepared using the set-up substantially described in Example 1. The substrate is a 7 mil thick oriented polystyrene thin film. TEOS is heated to 110 C and is carried in nitrogen at a concentration of 17 percent v/v and mixed with the balance gas, which is air. The adjusted flow rate of the TEOS is 425 sccm and the flow rate of the balance gas is 5 scfm (142000 sccm) and the concentration of TEOS based on the total gas mixture is calculated to be 2941 ppm. The oriented polystyrene thin film is coated for 10 seconds. The resultant coated film showed much improved anti-fog properties compared to the uncoated thin film. The resultant coated film has a surface energy of more than 50 dynes/cm.

### EXAMPLE 5

The coating is prepared using the set-up substantially described in Example 1. The substrate is a Thermoplastic Superabsorbent Polymer (TSAP) coextruded film (produced by the Dow Chemical Company) with a thickness of 4 mil (0.10 mm). TSAP is a melt compounded blend of a thermoplastic polymer and a superabsorbent polymer. Specifically the thermoplastic polymer is an ethylene and acrylic acid copolymer, having a weight percent acid from 9 percent to 20 percent, and the superabsorbent polymer is a partially neutralized crosslinked polyacrylate polymer. Ohter thermoplastic polymers and superabsorbent polymers can be used as described WO 02/07791 A2 and US 20020039869. The compounded blend is pelletized and the pellets are then fabricated as a monolayer or coextruded film using standard blown and cast film extursion processes.

Tetraethylorthosilicate (TEOS) is heated to 110 C and is carried in nitrogen at a concentration of 17 percent v/v and mixed with the balance gas, which is air. The adjusted flow rate of the TEOS is 510 sccm and the flow rate of the balance gas is 5 scfm (142000 sccm) and the concentration of TEOS based on the total gas mixture is calculated to be 3530 ppm. After 1 second of deposition time the resultant coating had the chemistry of SiOx. The resultant TSAP coated film shows much improved wetability compared with uncoated TSAP film.

### EXAMPLE 6

The coating is prepared using the set-up substantially described in Example 1. The substrate is a polymer foam prepared in the following way: An aqueous dispersion of an ethylene/1-octene copolymer is blended in a conventional mixing bowl with a frothing surfactant and an aqueous solution of an hydroxyalkyl cellulose ether. After the initial blend is prepared, air is entrained by mechanical frothing using a Hobart-type stand mixer (KitchenAid Professional mixer Model KSM50PWH) fitted with a wire whip. The mixer speed is increased from low to high over a period of approximately 3 to 10 minutes until a stiff froth is formed. Density of the froth is measured by weighing a 3 oz. (89 ml) paper cup filled with foam and whipping is stopped once the desired density of approximately 80 to 90 g/L is reached. The froth is spread on release paper supported by a stiffer paper sheet and is smoothed to a height of 0.05 in. The froth is placed in a Blue M forced air oven at drying temperature of about 75 deg C. for about 10 minutes. The dry foam sheet (0.04 in. thick) is recovered and yields durable foam having small cell sizes ranging from about 30 to 200 microns on the outer surfaces and larger cell size ranging from about 250 to 800 microns on the inner major surface.

Tetraethylorthosilicate (TEOS) is heated to 110 C and is carried in nitrogen at a concentration of 17 percent v/v and mixed with the balance gas, which is air. The adjusted flow rate of the TEOS is 510 sccm and the flow rate of the balance gas is 5 scfm (142000 sccm) and the concentration of TEOS based on the total gas mixture is calculated to be 3530 ppm. After 5 second of deposition time the resultant coating has the chemistry of SiOx. The resultant coated foam shows improved vertical wicking and improved wicking uniformity compared with uncoated polymer foam.

What is claimed is:

1. A process for depositing a film coating on the exposed surface of a substrate, characterized by the steps of: (a) creating a glow discharge in a region between an electrode and a counterelectrode; and (b) flowing a mixture comprising a balance gas, a tetraalkylorthosilicate and, optionally, a carrier gas for the tetraalkylorthosilicate through the glow discharge and onto or in the vicinity of at least one surface of said substrate at a flow velocity of from about 0.05 m/s to about 5 m/s, the concentration of the tetraalkylorthosilicate in the mixture being in the range of from more than 2000 ppm to about 10000 ppm to form a film coating on the substrate.

2. The process of claim 1 wherein the electrode is a perforated electrode comprising perforations threinto and the mixture of a balance gas and a tetraalkylorthosilicate and, optionally, a carrier gas for the tetraalkylorthosilicate is flowed through the perforations.

3. The process of claim 2 wherein the process is continuous and the counterelectrode supports a moving substrate.

4. The process of claim 3 wherein the counterelectrode is covered with a dielectric sleeve.

5. The process of claim 2 wherein the tetralkylorthosilicate is tetraethylorthosilicate.

6. The process of claim 2 wherein the balance gas is air, oxygen, nitrogen, helium, argon, or a combination thereof.

7. The process of claim 5 wherein the pressure of the glow discharge region is maintained at about atmospheric pressure and the concentration of the tetraethylorthosilicate is more than 3500 ppm.

8. The process of claim 7 wherein the flow velocity of the balance gas, the tetraethylorthosilicate, and the carrier gas through the perforations is in the range of from about 0.1 m/s to about 2 m/s.

9. The process of claim 7 wherein the coating has an optical clarity of at least 98 percent and a haze value of not greater than 2 percent.

10. The process of claim 1 wherein the film coating is a clear film coating.

11. The process of claim 1 wherein the film coating has a surface energy of more than 50 dynes/cm.
